(19) United States
(12) Patent Application Publication
(10) Pub. No.: US 2003/0170367 A1
(43) Pub. Date: Sep. 11, 2003

(54) Soluble black coffee

(76) Inventors: Peter Gaskell Fairhurst, Lausanne (CH); David Philippe Labbe, Lausanne (CH); Geraldine Ortega, Chavornay (CH)

Correspondence Address: WINSTON & STRAWN, PATENT DEPARTMENT, 1400 L STREET, N.W., WASHINGTON, DC, 20005-3502, US

(21) Appl. No.: 10/406,190

(22) Filed: Apr. 4, 2003

Related U.S. Application Data
(63) Continuation of application No. PCT/EP01/12585, filed on Oct. 31, 2000.

(30) Foreign Application Priority Data
Oct. 31, 2000 (EP) 00123715.5

(51) Int. Cl. A23F 5/00

(52) U.S. Cl. 426/594

(57) ABSTRACT

The invention relates to a method of improving acceptability of black coffee with young people. The method includes incorporating a plant flavor which is complementary to the coffee taste in an un-whitened soluble coffee powder and to the resulting product made by the method. In one embodiment, the soluble coffee beverage includes a plant flavor that initially provides a tea taste, but which subsequently gives away to a coffee taste in the mouth during consumption. The invention also relates to a coffee concentrate of this soluble coffee powder, and to coffee drinks or beverages made from same.

### CROSS-REFERENCE TO RELATED APPLICATIONS

The present application is a continuation of the US national phase of International application PCT/EP01/12585 filed Oct. 29, 2001, the content of which is expressly incorporated herein by reference thereto.

### FIELD OF THE INVENTION

This invention relates to a method of improving the acceptability of black coffee to the taste of young people. The invention also relates to a soluble black coffee powder with improved acceptability to and acceptance by young people.

### BACKGROUND OF THE INVENTION

Coffee beverage products of the instant type are well known. The classical type of instant coffee beverage is black soluble coffee. Usually, such products are soluble powders made from a spray or freeze-dried coffee extract. The black coffee beverage is prepared by mixing the soluble coffee powder with hot water. The resulting black coffee beverage may be consumed with or without a sweetener.

Consumer research has shown that black coffee has a strong and positive image among the 16-24 year old age group. In particular, black coffee and strong coffee were found to be positive attributes of coffee in general for this age group. However, at the same time it was found that the 16-24 year old age group do not particularly like the taste of black coffee. When this age group was asked what coffee beverages they wanted or liked to drink, beverages such as flavored cappuccino or creamy or unctuous drinks were found to be much more popular than black coffee whether or not it contains a sweetener.

At the same time, the 16-24 year old age group has been found to be well aware of the beneficial affects of caffeine in coffee and are often keen to make use of the caffeine alertness benefit. There is therefore a need for a black coffee beverage, which is acceptable in taste to the consumer, with a black coffee image of a recognizable coffee flavor, and which will allow the consumer to take advantage of the stimulation provided by caffeine in the coffee. A further need is to provide a black coffee beverage, which provides the convenience of soluble coffee. The present invention now satisfies these needs.

### SUMMARY OF THE INVENTION

The present invention now increases consumer acceptability of black coffee, in particular by young people. This is achieved in a soluble black coffee beverage which has increased consumer acceptability in particular with young people, and which at the same time provides the well know alertness benefit of caffeine in a beverage that has a desirable taste. Thus, the black coffee of the invention achieves increased consumer acceptability without the need for adding sugar or creamer.

Accordingly, in one aspect, the invention provides a method of improving the acceptability of black coffee to the taste of young people by incorporating in the coffee a plant flavor which is complementary to the coffee taste and providing this as an un-whitened soluble coffee powder. It is surprisingly found that the incorporation of a plant flavor which is complementary to the coffee taste in an un-whitened soluble coffee powder modifies the taste and that young people particularly like this taste. Thus, a coffee drink that includes the plant flavor has a taste that is complementary to that of coffee so that the taste is more palatable to young people compared to a coffee drink that does not contain the plant flavor.

In the present context plant flavor means plant extracts or plant aroma that are natural or are synthetically identical to natural products. Furthermore, in the present context an un-whitened soluble coffee powder or soluble black coffee means a soluble coffee powder which does not comprise milk, milk-based ingredients or non-dairy creamer in amounts capable of significantly whitening the coffee so that the coffee drink that is prepared has a black color.

It is preferred that the soluble coffee powder comprises from about 10% to about 50% by weight of coffee solids by weight of the total solid content of the powder, more preferably from about 15% to about 35% by weight. This gives a clearly recognizable coffee flavor to the product. It is further preferred that the soluble coffee powder comprises a soluble sweetener. Suitable types of soluble sweeteners are discussed below. If a sugar based soluble sweetener is used it is preferred to use from about 50% to about 90% of soluble sweetener by weight of the total solid content of the powder. This provides an appropriate level of sweetness to the product counteracting the inherent bitterness of coffee.

For certain plant flavors it is desirable to incorporate a texturant in the soluble powder. Preferably, the texturant is present in an amount from about 2% to about 20% by weight of the total solids content of the powder, and more preferably from about 3% to about 10% by weight. The texturant aids the aroma equilibrium that is perceived sensorially. If no or too little texturant is added, the product becomes too thin and loses body in the mouth. On the other hand if too much texturant is added, the product become too viscous and soup like.

The method according to the invention provides a reduction of the coffee intensity down to levels acceptable to the target consumer. At the same time however provides, the body, flavor and aroma delivery are kept at strong black cup levels by the addition of plant flavor, soluble sweetener and texturants. The consumer receives therefore a black cup of coffee where undesirable attributes have been removed, e.g., taste bitterness and too strong of a coffee flavor.

One embodiment of the invention which has been found to have a particular acceptability among young people is a soluble coffee beverage powder which provides a coffee beverage with a tea taste that subsequently gives away to a coffee taste in the mouth during consumption.

Another variety of the product which has been found to be preferred among young people is a soluble coffee beverage powder which provides a coffee beverage with a fresh taste and leaves a minty taste in the mouth at the end of consumption.

Other preferred embodiments of the invention will be discussed in the following.

In another aspect, this invention provides a black soluble coffee powder with improved acceptability to young people comprising, the soluble coffee powder incorporating a plant flavor which is complementary to the coffee taste in an un-whitened soluble coffee powder. The considerations as to preferred embodiments of the method of the invention also apply to the black soluble coffee powder. Further details of the black soluble coffee powder are given below.

In a further aspect, this invention provides a method of improving acceptability of black coffee with young people, the method comprising incorporating a plant flavor which is complementary to the coffee taste in an un-whitened coffee concentrate. The considerations as to preferred embodiment of the method of the invention also apply to the black coffee concentrate. Further details of the black coffee concentrate of the invention are given below.

### DETAILED DESCRIPTION OF THE PREFERRED EMBODIMENTS

Embodiments of the invention are now described, by way of example only. The invention provides a method of increasing the taste acceptability of black coffee among young people.

One method of the invention which has been found to make black coffee particular acceptability among young people is by providing a soluble coffee beverage powder which provides the coffee beverage with a tea taste that subsequently gives away to a coffee taste in the mouth during consumption. A black soluble coffee powder for this purpose preferably comprises from about 10% to about 50% of coffee solids by weight of the total solids content of the powder, from about 50% to about 90% by weight of sugar based soluble sweetener, from about 2% to about 20% by weight of texturant, and black tea solids. The amount of black tea solids is advantageously from about 1 to about 5% by weight of the black tea soluble solids. The tea flavor of the soluble coffee powder may be further enhanced by addition of essence or tea aroma. The black soluble coffee powder may incorporate further biscuit or cake flavors for an additional taste experience. The biscuit or cake flavor is preferably provided in the form of biscuit or cake aroma. In addition the black soluble coffee powder may incorporate bergamot flavor. The bergamot flavor is preferably provided in the form of bergamot aroma.

Another variety of the product which has been found to be preferred among young people is a soluble coffee beverage powder which provides a coffee beverage with a warm soft taste that complements the coffee taste. A black soluble coffee powder for this purpose preferably comprises from about 10% to about 50% of coffee solids by weight of the total solid content of the powder, from about 50% to about 90% by weight of sugar based soluble sweetener, from about 2% to about 20% by weight of texturant, and maple syrup flavor. Preferably, the maple syrup flavor should not be more than 5% maple syrup aroma, so that the coffee and maple syrup flavor will be balanced. More preferably the soluble coffee powder comprises from about 0.03 to about 5% wt of maple syrup aroma. The maple syrup aroma may be provided in maple syrup, or may be in the form of a separate aroma.

Another variety of the product which has been found to be preferred among young people is a soluble coffee beverage powder provides a coffee beverages with a mixture of plant aromas and a small amount of milk, milk-based ingredient, or non-dairy creamer sufficiently little to round off the taste. The amount of milk, milk-based ingredient or non-dairy creamer being so little that the coffee remains black. Preferably the amount is less than 2%, more preferably less than 1%, even more preferred less than 0.7%. The allowable amount present in the soluble coffee beverage powder for it to remain black depends on the protein content in the milk, milk-based ingredient or non-dairy creamer This type of un-whitened soluble coffee powder has a rounded full-bodied cup with an improved mouth-feel on the tongue during consumption.

It is preferred that the un-whitened soluble coffee powder comprises a warm aroma, with vanilla and similar flavorants being preferred. A desirable aroma profile is obtained when the warm plant aroma or warm flavor component is supplemented a honey aroma or flavor. In a further preferred combination, the soluble coffee powder further comprises flavors selected from the group consisting of nut flavors e.g. peanut, walnut, coconut, etc.. This provides a pleasant top-note to the product and increases the over the cup aroma concentration.

A further variety of the product which has been found to be preferred among young people is a soluble coffee beverage powder which provides a coffee beverage with a warm soft taste which complements the coffee taste and has an addition spicy note as the end taste. A black soluble coffee powder for this purpose preferably comprises from about 10% to about 50% of coffee solids by weight of the total solid content of the powder, from about 50% to about 90% by weight of sugar based soluble sweetener, from about 2% to about 20% by weight of texturant, and spices together with a warm flavor component. Preferably, the soluble coffee powder comprises less than about 0.5% by weight of spices. Advantageously, the spices are ethnic spices, preferably of Indian origin. The warm flavor components are preferably vanilla and/or honey aroma. A desirable taste balance is obtained when the soluble beverage powder comprises between about 0.5% and about 4% by weight of vanilla or honey aroma.

Another method of the invention which has been found to make black coffee particularly acceptable among young people is by providing a soluble coffee beverage powder which provides the coffee beverage with a fresh taste and leaves a minty taste in the mouth at the end of consumption. A black soluble coffee powder for this purpose preferably comprises from about 10% to about 50% of coffee solids by weight of the total solid content of the powder, from about 50% to about 90% by weight of sugar based soluble sweetener, and liquorice, mint and fennel flavors. Preferably, the soluble coffee powder comprises of liquorice flavor in the form of liquorice aroma. A preferred amount of liquorice aroma is less than about 1% by weight of liquorice aroma. It is preferred that the mint and fennel flavors are provided in the form of extracts. Preferably less than 1% by weight of mint extract and 1% by weight of fennel extract is incorporated into the soluble coffee powder.

Another variety of the product which has been found to be well accepted among young people is a soluble coffee beverage powder which provides a coffee beverage with a fruit taste which subsequently gives away to a coffee taste in the mouth during consumption. A black soluble coffee powder for this purpose preferably comprises from about 10% to about 50% of coffee solids by weight of the total solids content of the powder, from about 50% to about 90% by weight of sugar based soluble sweetener, fruit flavor and an organic acid such as citric acid. Preferably, the fruit flavor is provided in the form of fruit powder, for example from about 2% to about 10% by weight of fruit powder. A preferred amount of citric acid is less than about 1% by weight, more preferably from about 0.02 to 0.5% by weight of citric acid. The citric acid improves the harmony of the fruit and coffee flavors hence improving the equilibrium of the drink. Too much citric acid leads to a drink that is too acidic and no longer balanced.

For the preparation of the beverage, conveniently powdered coffee solids are used originating from coffee liquor. The coffee liquor may be obtained using any suitable procedure. Usually, the coffee liquor is prepared by concentrating a coffee extract obtained from a coffee extraction process to the desired coffee concentration. The coffee extract may be produced in the usual manner by subjecting roasted coffee beans to extraction. Any suitable extraction procedure may be used because the choice and design of the extraction procedure is a matter of preference and has no critical impact on the invention. Suitable extraction procedures are described in U.S. Pat. Nos. 5,897,903 and 5,997,929; the disclosures of each of which are expressly incorporated herein by reference thereto. Similarly, any suitable concentration procedure may be used because the choice and design of the concentration procedure is a matter of preference and has no critical impact on the invention. Of course, the coffee liquor may also be prepared by dissolving soluble coffee powder in water to the desired concentration.

Coffee replacers or surrogates such as chicory may also be used. This will provide a cup profile which is less aromatic and has no coffee aroma at all.

For the production of soluble coffee, merely processing the roasted coffee beans to a coffee base concentrate as described above will result in the loss of substantially all coffee aroma. Therefore, it is preferred to specifically strip off and then collect the coffee aroma during processing. In this way, the coffee aroma is not lost. Processes for stripping off and collecting the coffee aroma are well known. Usually coffee aroma is stripped off at one or more stages; for example:

using an inert gas or steam during, or immediately after, grinding of the coffee beans, and

using steam to strip coffee aroma from the coffee extract during extraction.

Alternatively, the fresh coffee grounds may be slurried in water or coffee extract and the coffee aroma stripped from the slurry. A suitable procedure is described in U.S. Pat. No. 6,149,157; the disclosure of which is expressly incorporated herein by reference thereto.

The coffee aroma may be captured using any suitable procedure. Ordinarily, the coffee aroma is captured by condensing from the carrier gas in one or more condensers. Preferably more than one condenser is used; each succeeding condenser being operated at a lower temperature than the previous condenser. If necessary or desired, one of the condensers may be a cryogenic aroma condenser. A suitable cryogenic aroma condenser is described in U.S. Pat. No. 5,182,926; the disclosure of which is expressly incorporated herein by reference thereto. The captured coffee aroma may, if desired, be concentrated using a suitable technique such as partial condensation or rectification. The captured coffee aroma may be combined with a suitable carrier substrate such as coffee oil or emulsion containing coffee oil or other fats. Aqueous coffee aroma components and organic coffee aroma components are then separated. A suitable method for separating aqueous coffee aroma components from organic coffee aroma components are described in co-pending U.S. patent application Ser. No. 20020018839A1; the disclosure of which is expressly incorporated herein by reference.

The processes for the production of the coffee extract and capture of the coffee aroma may be carried out under oxygen reduced or oxygen free conditions if desired. This may be accomplished as is known in the art; for example by carrying out the processes under a blanket of inert gas. Further, deoxygenated water may be used whenever water is necessary in the process.

The coffee aroma is preferably stored under oxygen reduced or oxygen free conditions and frozen. Similarly, the coffee base concentrate may be stored under oxygen reduced or oxygen free conditions. Further, if desired, oxygen scavengers may be added to the coffee aroma and/or coffee base concentrate. Suitable oxygen scavengers are described in U.S. Pat. No. 6,093,436; the disclosure of which is expressly incorporated herein by reference thereto.

The soluble beverage powder preferably contains about 0.05% to about 0.2% by weight of coffee aroma components.

It is desirable that the soluble coffee beverage powder also includes a soluble sweetener; natural or artificial. Suitable examples include sucrose, fructose, lactose, maltose, saccharin, cyclamates, acetosulfame, L-aspartyl based sweeteners such as aspartame, and the like, and mixtures of these. The amount of the sweetener used will vary depending upon the desired level of sweetness and the strength of the sweetener. However for sugar based sweeteners, such as fructose, glucose and sucrose etc., the total amount of sweeteners is preferably in the range of about 50% to about 90% by weight. The soluble sweetener may also be combined with bulking agents such as maltodextrins and polydextrose; particularly if an artificial sweetener is used. In this case, the total amount of sweetener and bulking agent is usually in the range of about 10% to about 25% by weight; artificial sweetener itself usually comprising less than 1% by weight.

In some embodiment of the soluble beverage according to the invention, the beverage powder also preferably comprises a texturant to a) give the beverage more body and b) to round and smooth the sensory perception of certain added aromas. The texturants have been found to be particularly suitable when used in combination with warm flavors such as maple, honey, vanilla and biscuit. Suitable texturants are carboxymethlcellulose (CMC) or pectins. It has been found that the amount of texturants will depend on the aromas added and the amount of body desired for the product. If too little texturant is added the product becomes too thin and loses body in the mouth, the aroma equilibrium as perceived sensorially also becomes less balanced. If too much texturant is added the product becomes soup like and too viscous.

Advantageously, the soluble coffee powder comprises from about 2% to about 20% of texturant by weight of the total solids content of the powder, preferably from about 5% to about 7% by weight of texturant. The appropriate amount of texturant will depend upon the different dosage for the different beverages. For example, a preferred amount of texturant is from 100 to 400 mg for a 100 ml serving.

The plant flavor may be a plant extract or plant aroma natural and/or natural identical. The plant extracts and/or aromas may be added to the coffee at the same time as the sugar. The product may then be dry mixed to produce a substantially homogeneous product. The mixture then undergoes a texturization process (agglomeration, freeze-drying or other). An alternative method that may be used involves performing a texturization on the sugar and coffee mix, and then spraying the aromas onto the resulting texture.

The ingredients of the beverage powder may be dry mixed. If a freeze drying texturization operation is used, a wet mix is used. The liquid used for wet mixing may conveniently be coffee liquor.

Subsequently, the wet mix may be gassed by injecting of a gas such as nitrogen or carbon dioxide into it. The gas is then dispersed within the mixture by means of a dispersing machine and the gassed mixture is then passed onto a homogenizer. The gassing may be used to control the eventual density of the powder and to improve the solubility of the product.

The wet mix may be dried by means of any conventional drying techniques such a freeze-drying or spray drying.

For freeze drying the coffee/soluble sweetener/plant extract and/or aroma wet mix is frozen on a band at temperatures between −30 and −50° C. The product is then dried under a vacuum where the water is removed by sublimation.

For spray-drying the product is atomized into small droplets and the water in the product is removed by the hot air in a drying tower.

Subsequent to the drying, the powder may be cooled in a fluidized bed cooler.

It is preferred that the tapped specific gravity of the powder is in the range from about 200 to about 400 g/l, more preferred is a tapped specific gravity between about 250 and about 300 g/l. Tapped specific gravity is referring to the gravity of the powder when compressed by vibrating the powder with 100 pushes of 10 mm.

As mentioned above, the soluble coffee powder may be agglomerated to give a texture to the powder a better wettability or to obtain a more desirable appearance of the powder.

### EXAMPLES

Specific examples are now described to further illustrate the invention.

In another embodiment the invention relates to a method of improving acceptability of black coffee with young people, the method comprising incorporating a plant flavor which is complementary to the coffee taste in an un-whitened coffee concentrate. A coffee concentrate may conveniently be prepared by adding a liquid, preferably water, to a soluble coffee powder as described above. Such a concentrate would be prepared by adding the required amount of water to the powder (generally to produce a concentrate of 20-40% solids concentration) and stirring until complete dissolution of the powder. The concentrate would then be sterilized before aseptic filling into any packaging with acceptable barrier properties, bottles, sachets etc.

### Example 1

Preparation of the of Coffee Beverage Powder

Samples of coffee beverage powder according to the invention are prepared with the following ingredients that are dry mixed for the purpose of the examples. The soluble black coffee used is Nescafé™ product that is commercially available from Nestlé S.A. in France and Switzerland.

Samples 1a

Conventional coffee powder at a percentage of 10-30% wt is dry mixed with a sugar based soluble sweetener 60-70% wt. When a homogeneous mix is obtained 0.5-5% wt black tea extract and 2-10% wt texturant are added. The coffee beverage powder is then dry mixed until a homogeneous.

Samples 1b

Conventional coffee powder at a percentage of 10-30% wt is dry mixed with a sugar based soluble sweetener 60-80% wt. When a homogeneous mix is obtained 0.5-5% wt black tea extract and 2-10% wt texturant are added and mixed. Then 0.1-1% of a biscuit aroma is added. The coffee beverage powder is then dry mixed until a homogeneous.

Samples 1c

Conventional coffee powder at a percentage of 10-30% wt is dry mixed with a sugar based soluble sweetener 60-80% wt. When a homogeneous mix is obtained 3-10% wt texturant and 0.4-2% maple syrup aroma are added. The coffee beverage powder is then dry mixed until a homogeneous.

Samples 1d

Conventional coffee powder at a percentage of 10-30% wt is dry mixed with a sugar based soluble sweetener 60-80% wt. Then 3-8% wt texturant, 0.1-3% wt Indian spices, and 0.1 to 2% wt of vanilla aroma are added. The coffee beverage powder is then dry mixed until a homogeneous.

Samples 1e

Conventional coffee powder at a percentage of 10-30% wt is dry mixed with a sugar based soluble sweetener 60-90% wt. Then 0.05-2.0% wt liquorice, fennel and mint plant extracts and aromas are added. The coffee beverage powder is then dry mixed until a homogeneous.

Samples 1f

Conventional coffee powder at a percentage of 10-30% wt is dry mixed with a sugar based soluble sweetener 60-90% wt. Then 1-10% wt fruit powder and 0.01-0.5% wt are added to the coffee powder-sugar mix. The coffee beverage powder is then dry mixed until a homogeneous.

Samples 1g

Conventional coffee powder at a percentage of 10-30% wt is dry mixed with a sugar based soluble sweetener 60-80% wt. When a homogeneous mix is obtained 0.5-1% of non-dairy creamer and 2-10% wt texturant are added and mixed. Then 1-4% of total aromas are added. The coffee beverage powder is then dry mixed until a homogeneous.

### Example 2

Preparation of the of Coffee Beverage

To prepare the beverage about 8 g of powder are spooned into a mug. About 200 ml of hot water 70-80° C. are then added to the cup and the solution is then stirred by a spoon to ensure that all the powder has dissolved. The beverage is then ready to be consumed.

A trained panel tasted the samples of 1a-f panelist found that:

Samples 1a have a tea tastes which subsequently gives away to a coffee taste in the mouth.

Samples 1b have a tea tastes which subsequently gives away to a coffee taste in the mouth. In addition samples 1b have a warm flavor of biscuit.

Samples 1c have a warm soft taste, which complement the coffee taste.

Samples 1d have a warm soft taste, which complement the coffee taste and additionally a spicy flavor as end taste.

Samples 1e have a fresh taste and leaves a minty taste in the mouth at the end of consumption.

Samples 1f have a fruit tastes, which subsequently gives away to a coffee taste in the mouth.

### Example 3

Consumer Acceptance Test

A comparative confidential test is conducted with a panel of 30 untrained 18-26 years old consumers. The consumers are asked to compare the samples prepared according to samples 1a-f and then by the method outlined in example 2 with beverages prepared from the classical commercially available black soluble coffee used in the formulations described in examples 1a-1f including the same amount of sugar, and comparable dosing.

In all cases examples 1a-1f the majority of the panelists find that the samples 1a-1f are more acceptable and pleasant compared to classic soluble coffee beverage with the same amount of sugar.

Further to this point it would appear that certain of these beverages which have a coffee character are equally acceptable to non-coffee and coffee drinkers is the 18-26 year old age group.

What is claimed is:

1. A method of improving acceptability of black coffee with young people, which method comprises incorporating in an un-whitened soluble coffee powder a plant flavor which has a taste that is complementary to that of coffee so that a coffee drink prepared from the powder has a taste that is more palatable to young people compared to a coffee drink that does not contain the plant flavor.

2. The method according to claim 1, which further comprises incorporating in the coffee powder a plant flavor that initially provides a tea taste to the coffee drink which tea taste subsequently gives way to a coffee taste in a consumer's mouth.

3. The method according to claim 1, which further comprises incorporating in the coffee powder a plant flavor that initially provides a fresh taste to the coffee drink and leaves a minty taste in a consumer's mouth at the end of consumption.

4. The method according to claim 1, which further comprises incorporating in the coffee powder a plant flavor that initially provides a fruit taste to the coffee drink which taste subsequently gives way to a coffee taste in a consumer's mouth.

5. The method according to claim 1, which further comprises incorporating in the coffee powder a plant flavor that provides a warm soft taste to the coffee drink which taste complements that of the coffee.

6. The method according to claim 1, which further comprises incorporating in the coffee powder a plant flavor that provides a spicy flavor as an end taste.

7. The method according to claim 1, which further comprises incorporating in the coffee powder coffee solids in an amount of from about 10% to about 50% by weight of total solids of the powder.

8. The method according to claim 1, which further comprises incorporating in the coffee powder a sweet taste perceptible amount of a soluble sweetener.

9. The method according to claim 8, wherein the sweetener is a sugar-based soluble sweetener and is present in an amount of from about 50% to about 90% by weight of total solids of the powder.

10. The method according to claim 1, which further comprises incorporating in the coffee powder a texturant in an amount effective to aid in sensorial perception of aroma equilibrium of the coffee drink.

11. The method according to claim 10, wherein the texturant is present in an amount of from about 2% to about 20% of total solids of the powder.

12. The method according to claim 1, which further comprises incorporating black tea solids in the coffee powder in an amount sufficient to change the taste of the coffee.

13. The method according to claim 1, which further comprises incorporating maple syrup flavor in the coffee powder in an amount sufficient to change the taste of the coffee.

14. The method according to claim 1, which further comprises incorporating spices together with a warm flavor component in the coffee powder in an amount sufficient to change the taste of the coffee.

15. The method according to claim 1, which further comprises incorporating liquorice, mint and fennel flavor in the coffee powder in an amount sufficient to change the taste of the coffee.

16. The method according to claim 1, which further comprises incorporating a fruit flavor and citric acid in the coffee powder in an amount sufficient to change the taste of the coffee.

17. The method according to claim 1, which further comprises incorporating a nut flavor together with a warm flavor component in the coffee powder in an amount sufficient to change the taste of the coffee.

18. A black soluble coffee powder with improved acceptability to young people comprising a soluble coffee powder that includes a plant flavor which has a taste that is complementary to that of coffee so that a coffee drink prepared from the powder has a taste that is more palatable to young people compared to a coffee drink that does not contain the plant flavor.

19. The black soluble coffee powder according to claim 19, further comprising a sweet taste perceptible amount of a soluble sweetener.

20. The black soluble coffee powder according to claim 19, further comprising a texturant in an amount effective to aid in sensorial perception of aroma equilibrium of the coffee drink.

21. The black soluble coffee powder according to claim 19, which comprises:
coffee solids in an amount of from about 10% to about 50% by weight of total solids of the powder,
a sugar based soluble sweetener in an amount of from about 50% to about 90% by weight,
a texturant in an amount of from about 2% to about 20% by weight, and
black tea solids in an amount sufficient to change the taste of the coffee.

22. The black soluble coffee powder according to claim 21, wherein the black soluble coffee powder incorporates a biscuit or cake flavor.

23. The black soluble coffee powder according to claim 21, wherein the black soluble coffee powder incorporates a bergamot flavor.

24. The black soluble coffee powder according to claim 19, which comprises:
coffee solids in an amount of from about 10% to about 50% by weight of total solids of the powder,
a sugar based soluble sweetener in an amount of from about 50% to about 90% by weight,
a texturant in an amount of from about 2% to about 20% by weight, and
maple syrup flavor in an amount sufficient to change the taste of the coffee.

25. The black soluble coffee powder according to claim 19, which comprises:
coffee solids in an amount of from about 10% to about 50% by weight of total solids of the powder,
a sugar based soluble sweetener in an amount of from about 50% to about 90% by weight,
a texturant in an amount of from about 2% to about 20% by weight, and
spices together with a warm flavor component in amounts sufficient to change the taste of the coffee.

26. The black soluble coffee powder according to claim 19, which comprises:
coffee solids in an amount of from about 10% to about 50% by weight of total solids of the powder,
a sugar based soluble sweetener in an amount of from about 50% to about 90% by weight,
a texturant in an amount of from about 2% to about 20% by weight, and
liquorice, mint or fennel flavor in amounts sufficient to change the taste of the coffee.

27. The black soluble coffee powder according to claim 19, which comprises:
coffee solids in an amount of from about 10% to about 50% by weight of total solids of the powder,
a sugar based soluble sweetener in an amount of from about 50% to about 90% by weight,
a texturant in an amount of from about 2% to about 20% by weight, and
fruit flavor and citric acid in amounts sufficient to change the taste of the coffee.

28. The black soluble coffee powder according to claim 19, which comprises:
coffee solids in an amount of from about 10% to about 50% by weight of total solids of the powder,
a sugar based soluble sweetener in an amount of from about 50% to about 90% by weight,
a texturant in an amount of from about 2% to about 20% by weight, and
nut flavor together with a warm flavor component in amounts sufficient to change the taste of the coffee.

29. The black coffee concentrate of claim 19 which is made of an un-whitened coffee concentrate.

30. A black coffee concentrate comprising a black soluble coffee powder according to claim 19 and water.
